(19) United States
(12) Patent Application Publication
(10) Pub. No.: US 2003/0043053 A1
(43) Pub. Date: Mar. 6, 2003

(54) Spread spectrum radio control system for models

(76) Inventor: Michael L. Schuckel, Woodburn, IN (US)

Correspondence Address: O'MALLEY AND FIRESTONE, 919 SOUTH HARRISON STREET, SUITE 210, FORT WAYNE, IN, 46802, US

(21) Appl. No.: 09/943,850

(22) Filed: Aug. 31, 2001

(51) Int. Cl. G08C 19/00

(52) U.S. Cl. 340/825.69

(57) ABSTRACT

The invention provides for the radio control of model airplanes, cars, helicopters and the like using frequency hopping spread spectrum transmissions, preferably in the Industrial Scientific Medical (ISM) spectrum bands. A method and apparatus for translation of pulse duration modulation (PDM) servo control signals into digital signals for application to a spread spectrum transmitter in hand held control units and for their recovery in the models are provided.

### BACKGROUND OF THE INVENTION

1. Field of the Invention

The invention relates to radio control systems for model boats, airplanes, gliders, cars and the like, and, more particularly, to a spread spectrum radio control system providing digital encoding of conventional pulse duration modulation (PDM) control signals for frequency skipping transmission, thereby reducing the potential for interference among modelers operating multiple vehicles in close proximity to one another and potentially providing greater bandwidth for the use of hobbyists.

2. Description of the Problem

Radio controlled model airplanes, cars and boats have developed a large following among the public. Radio controlled models typically include several servo controlled systems such as throttles, rudders, ailerons, brakes and similar systems which allow control over speed and direction of the vehicle by the application of PDM control signals. These signals are generated by a hand held controller as determined by the manual positioning of joysticks, control levers and switches on the controller. While such controllers could be hardwired to the model, maximum freedom in maneuverability and the possibility of interaction between different hobbyists is achieved using wireless communication between the handheld controller and servo pulse utilizing circuitry on the model. Conventionally such wireless communication has meant radio.

Competitions add greatly to the excitement of the hobby of radio controlled models and can attract numerous hobbyists. The Federal Communications Commission (FCC) has established a frequency band set aside for modelers' use, defined fifty channels within that band and set power limits on transmissions within that band. The band has a frequency range from between 72.01 MHZ to 72.99 MHZ. The fifty channels each have 20 kHz bandwidths. Obviously the possibility for conflict in frequency use between modelers at even small competitions, or at any open, public area that attracts the hobbyists, is substantial. Interference on a channel between two users can easily result in the loss of an expensive model. Additionally, the small bandwidth allotted to each channel limits the number of model variables that can be controlled and has limited the availability of telemetry systems returning data back to the controller from the model.

### SUMMARY OF THE INVENTION

The invention provides for the radio control of model airplanes, cars, helicopters and the like using spread spectrum transmissions, preferably operating in the Industrial Scientific Medical (ISM) bands. Data transmission uses currently licensed spread spectrum transceivers. In a preferred embodiment, pulse duration modulation (PDM) servo control signals are translated into digital signals for a spread spectrum transmitter in hand held control units and are recovered in decoder units installed on the models.

One aspect of the invention provides conversion of the PDM servo signals into packets of digital data and for regenerating the PDM signals in the model being controlled. In conventional model control, a control signal for all of the controlled variables of a model vehicle comprises a reference pulse, followed by eight or nine duration modulated channel pulses. The following reference pulse marks the beginning of another set of control pulses. The recurring control pulses are related to particular servos by the order in which they occur between the reference pulses. For example, the first pulse may represent throttle position, the second pulse may relate to elevator position, and so on until all eight or nine available channels are used. The control pulses or “channel pulses” represent data by variation in their duration. Channel pulse duration represents a specific numerical value relating to control of a variable such as rudder position. Each channel pulse represents data relating to a particular controllable variable for the model. A converter provides for detection of the leading and trailing edges of the pulses, measurement of their duration and generation of a packet of data in which the first byte indicates the channel (e.g. rudder) and the remaining bytes represent the pulse's duration. At 115,200 baud, a three byte packet can be generated within the fixed 400 μS gap between pulses.

Recovery of data at a receiving station regenerates the individual pulse duration channel pulses, sorted and directed to the proper servos. The receiving unit may use parallel channels, which sort the packets and distribute pulse regeneration to avoid overlap of one regenerated channel pulse with a following pulse.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a view illustrating the environment of use of a preferred embodiment of the present invention.

FIG. 2 is generalized block diagram of the control system used in the preferred embodiment of the invention.

FIG. 3 is a timing diagram illustrating a pulse position modulation (PPM)/pulse duration modulation (PDM)) signal generated to serve as a multiple servo control signal.

FIG. 4 is a high level block diagram of the transmitting electronics of the control system.

FIG. 5 is a high level block diagram of the receiving electronics of the control system.

FIG. 6 is a diagram of the transmission electronic illustrating in greater detail one embodiment of the invention.

FIG. 7 is a flow chart of the programming executed by the programmable element of the FIG. 6.

FIG. 8 is a detailed circuit schematic of a receiving unit for one embodiment of the control system of the present invention.

FIG. 9 is a flow chart for the program executed by each of the programmable elements of the receiving unit of FIG. 8.

FIG. 10 is a high level block diagram of the electronics for a hand held controller for an alternative embodiment of the invention.

### DETAILED DESCRIPTION OF THE INVENTION

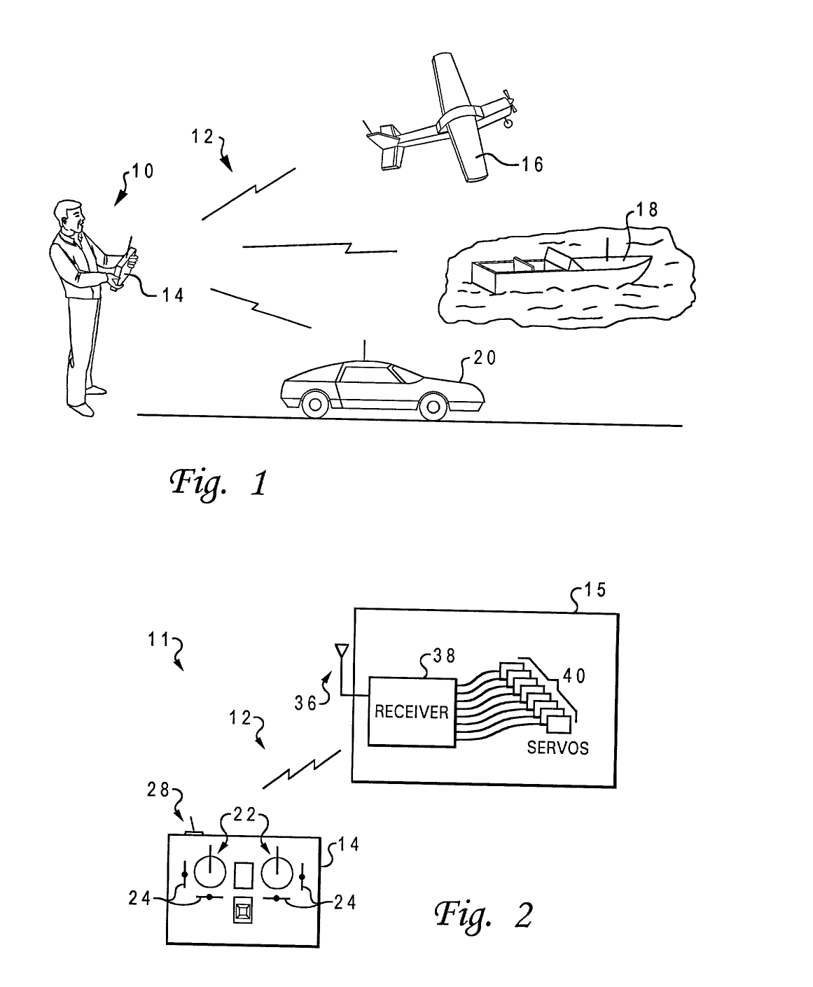

In FIG. 1 a user 10 is illustrated remotely operating any one of three model vehicles such as a model airplane 16, a model boat 18, or a model car 20, remotely. Control is effected through a hand held unit 14 which transmits electromagnetic control signals, preferably radio signals 12, to the model vehicles. Hand held unit 14 provides conventional joysticks, joystick position scanning elements and pulse duration modulation generating circuitry.

Referring now to FIG. 2, a remote control system 11 is illustrated in a general overview for a typical application controlling a model vehicle 15. Hand held unit 14 houses a pair of channel control joysticks 22. Each joystick 22 controls two channels. Moving one of a joysticks 22 sideways will control one channel, for example the ailerons on a model airplane 16. Movement of the same joystick 22 front to back can control a second channel, for example the elevator. The remaining joystick 22 will likely then provide for rudder control with side to side movement and throttle control with back and forth movement. Trim tab controls 24 are provided in each axis of movement of joy sticks 22. The neutral or center position for each joystick in each axis of movement can be adjusted by the trim tabs 24. Additional proportional controls 42, 44, 46 and 48 may use any remaining channels of an eight or nine channel set for an aircraft in lieu of trim tabs 24.

Signals 12 are transmitted from hand held unit 14 via an antenna 28 and received by a model vehicle 15 on an antenna 36. Antenna 36 is connected to a receiver unit 38 which decodes control signals directed to each of eight (or nine) servos 40.

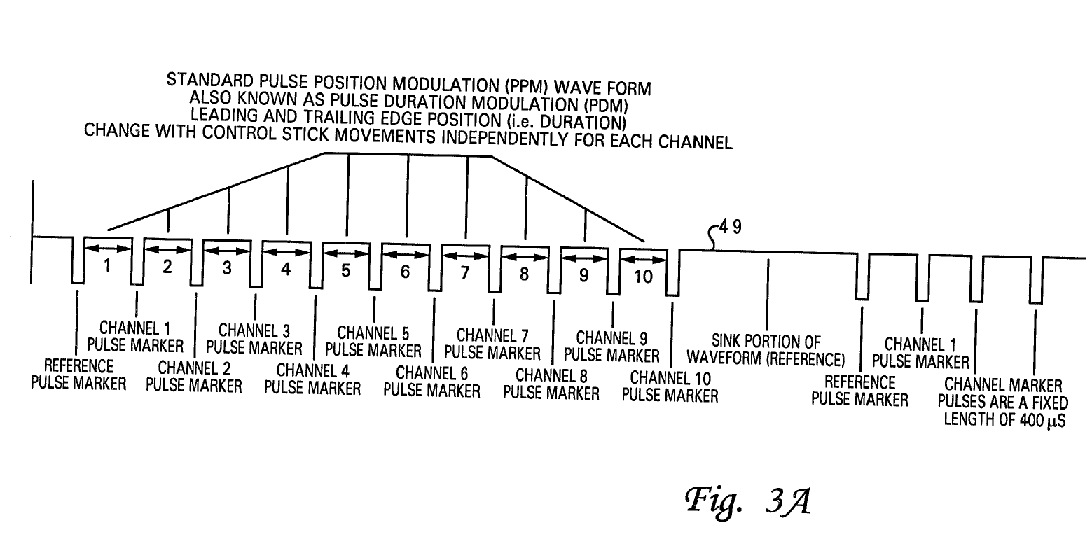

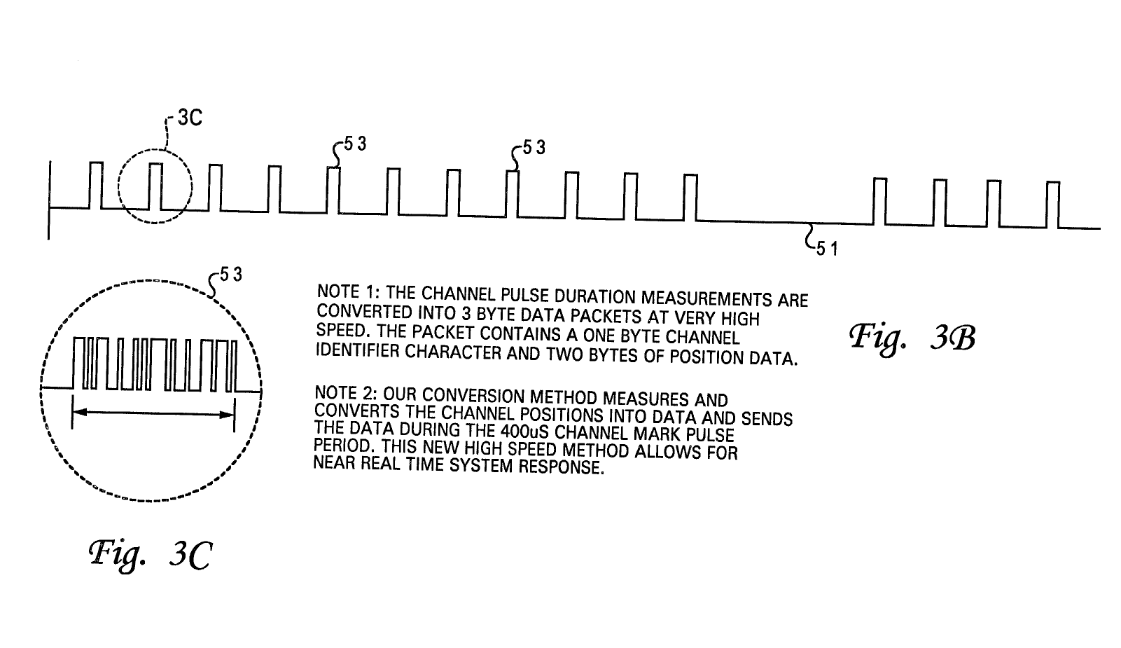

FIGS. 3A-C are timing diagrams illustrating the data coding and transmission provided by the invention for pulse duration modulation waveforms. Pulse duration is sometimes called pulse position or pulse width modulation, the latter term being commonly employed when referring to pulse width modulated drives or servos. As has already been described, model vehicles include servos responsive to pulse duration modulation control waveforms. The use of such control signals has been long known and forms no part of the invention. The invention provides a new system for the transmission and remote reception of such signals, particularly to overcome the problem of there being too few frequency slots available in the allotted bandwidth for radio broadcast of remote control signals for models. The invention makes use of bandwidth in the Industrial Scientific Medical Bands (ISM), particularly the 2.4-2.5 Ghz band, which is available for unlicensed use.

A number of commercially available, FCC compliant, frequency hopping spread spectrum transceivers are available for use in the ISM bands. Among transceivers preferred here are the WIT 2400 and 2410 transceivers available from Cirronet of Atlanta, Ga. and the ConnexRF transceivers available from AeroComm, Inc. of Lenexa, Kans. These devices operate on digital data. PDM signals do not meet this criterion. In one aspect, the invention provides for conversion of PDM signals into fixed length digital code, and for the recovery of the PDM signals from the fixed length digital code. The conversion and recovery are preferably fast enough to be used in a real time control system, and result in no sense of sluggishness in response to the human user of the control system.

Model controllers provide PDM signals in accord with a defined format characterized by the waveform or scan signal 49 of FIG. 3A. Scan signal 49 includes a recurring series of control pulses relating to each controlled variable, e.g. rudder position or throttle setting, and a reference or synchronization pulse occurring between each set of control pulses. The reference pulse is of a predefined duration (5.2 mS) exceeding the maximum permitted duration of control pulses. The duration of the control pulses varies between a minimum of 840 μS to a maximum of 1.8 mS, and relates the position of the joysticks, or other input devices, to control servos installed on the model vehicle. Between two occurrences of reference pulses, a control or “channel” pulse occurs for each controlled variable once, with the order in which control pulse occurs defining which controlled variable the pulse is related to. These pulses are conventionally referred to as “channels”. Systems generally come with eight or nine channels, although ten are shown in waveform 49 for purposes of illustration. Channels are separated by pulse markers which have a fixed duration of 400 μS. The order of the channel pulses is determined by the scan order of the joysticks, which is fixed in advance.

The preferred embodiment of the invention works with pulse forms which vary in duration. This requires detection of the leading and trailing edges of a pulse for measurement of the elapsed time between the two events. Other types of pulse position modulation signals may be used, such as where the relative position of the leading edges of the pulses relative to the reference pulse is detected and timed.

FIG. 3B illustrates output windows 53 occurring in a timeline 51 following conversion of the PDM waveform 49. The output windows correspond in time to the occurrence of pulse markers following channel pulses. Within each window is placed a data packet relating to the just completed channel pulse. The data packet comprises three bytes, the first of which identifies the order in the sequence of the pulse to which the code relates (i.e. the channel) and the second and third bytes are a quantization of the duration of the pulse. FIG. 3C illustrates insertion of three bytes of digital data into a window 53. At 115,200 baud the transmission o three bytes of data requires 340 μS, neatly fitting within the 400 μS gap.

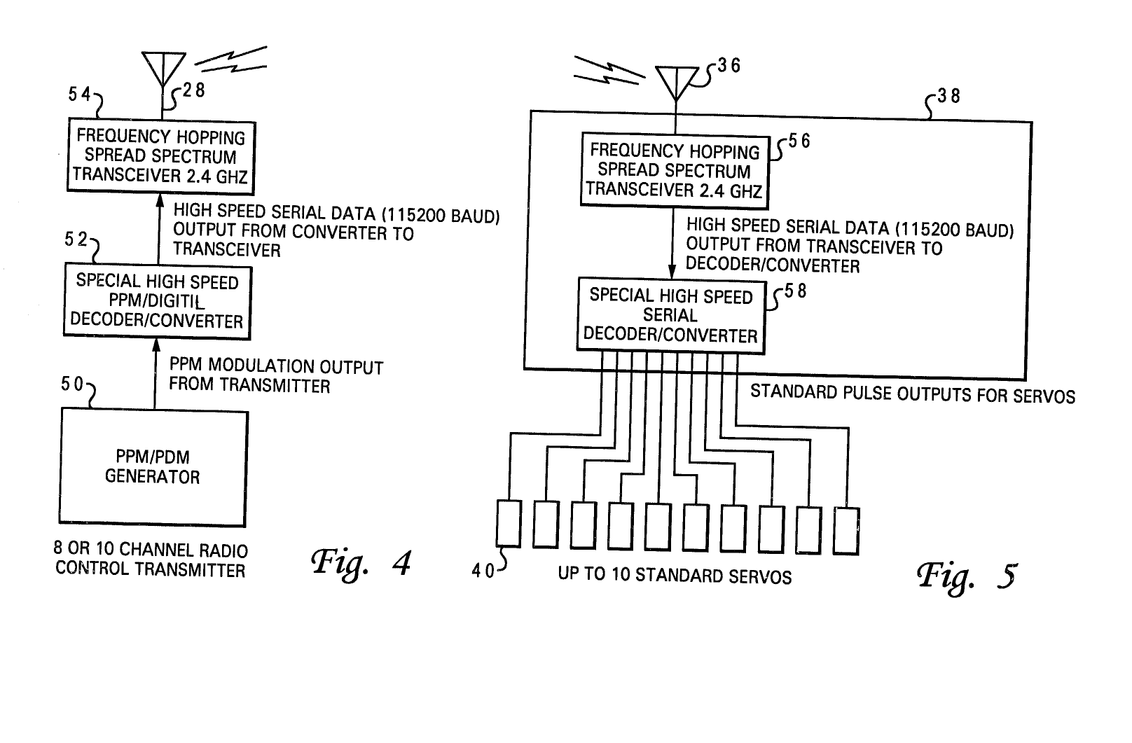

FIG. 4 illustrates at a high level the arrangement of a transmitter associated with a hand held control unit. A unit will include a PPM/PDM generator 50, which includes joysticks or comparable input devices, joystick position scanning, pulse generation responsive to the scanned joystick position and circuitry for the generation of a waveform including pulses associated with each controlled channel in a sequence in accord with the prior art. The waveform is applied to a high speed PDM waveform to digital converter 52, which generates serial digital data suitable as an input to a commercially available frequency hopping spread spectrum transceiver 54 operating in an ISM band. Transceiver 54 broadcasts the spread spectrum signal over an antenna 28. The use of transceivers offers the eventual possibility of adding full duplex communications between hand held units and controlled units. As is well known, spread spectrum is a modulation technique allowing multiple access to a bandwidth and for increasing the immunity to noise and interference. Spread spectrum systems make use of a sequential noise like structure, typically generated by pseudo-random frequency hopping for carriers, to distribute the normally narrow band information signal over a relatively wide band of frequencies. The receiver correlates these signals to the retrieve the original information signal. Many different algorithms may be used for generating the frequency skips, allowing many hobbyists simultaneously to use a given band of frequencies.

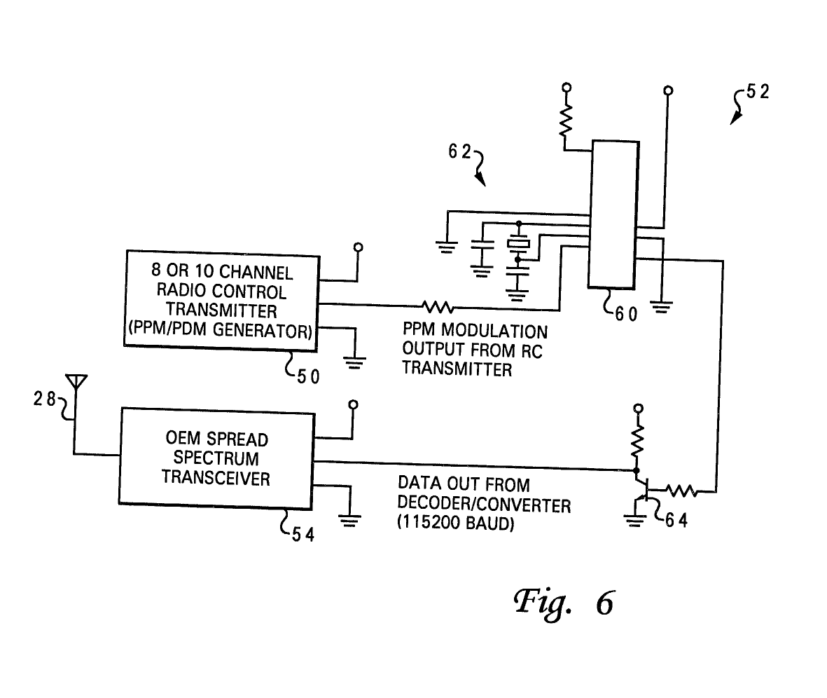

FIG. 5 is a high level illustration of a controlled unit including an antenna 36, and a receiving/decoding section 38. Receiving/decoding section 38 receives digital data which has been modulated and spread spectrum broadcast and recovers therefrom the PPM/PDM signals for application to each of a plurality of servos 40. Section 38 includes an OEM frequency hopping spread spectrum transceiver 56 which is synchronized with transceiver 54 by use of the same pseudo-randomizing algorithm for selection of carrier frequencies. High speed serial digital data is provided from the transceiver 56 to a pulse recovery section 58. Pulse recovery 58 applies the appropriate control pulse to each servo 40.

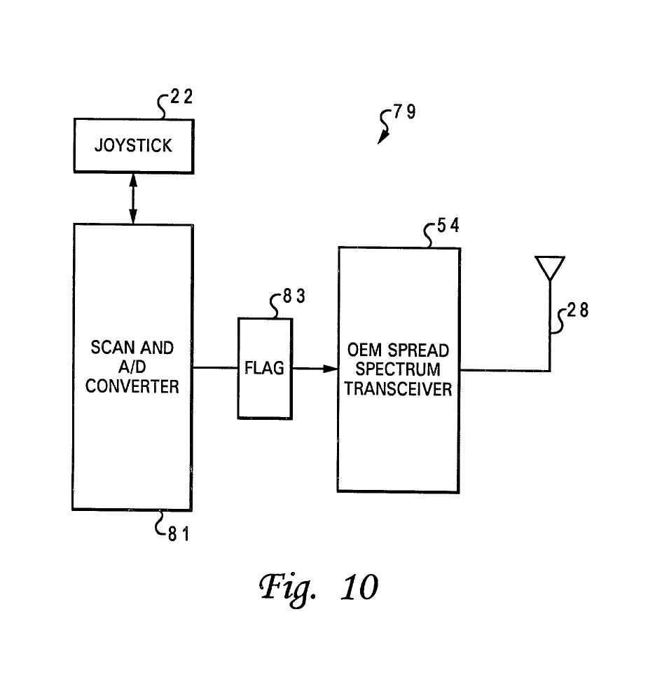

FIG. 6 illustrates in greater detail of the PPM/PDM converter 52. The main component of converter 52 is a PIC16F873 programmable microcontroller 60. The PIC16F873 microcontrollers are field programmable, RISC-based 16 bit microcontrollers available from Microchip Technology, Chandler, Ariz. Microcontroller 60 is connected to an external clock signal generator 62. Current versions of microcontroller 60 are clocked at about 22 MHZ. PPM/PDM output from PPM/PDM generator 50 is applied to one input pin of microcontroller 60 and serial digital data is provided as an output to an amplifying driver 64 for eventual application to a spread spectrum transceiver 54 and broadcast over antenna 28. The serial digital data rate is 115200 baud. The highly modular aspect of the elements of the invention should allow the converter and transmitter to be readily incorporated into existing designs for hand held units without redesign of the PDM waveform generating circuitry. It is possible to redesign the hand held units so that joystick position is subject to direct analog to digital conversion after scanning, as is done with joysticks used with personal computers, and then encoded in a digital format. This would avoid the need to convert PDM signals before application to the spread spectrum transceiver. PDM signals could still be generated at the receiving end for application directly to the servos. See FIG. 10 below for a block diagram of a controller, based on this approach, usable with an alternative embodiment of the invention.

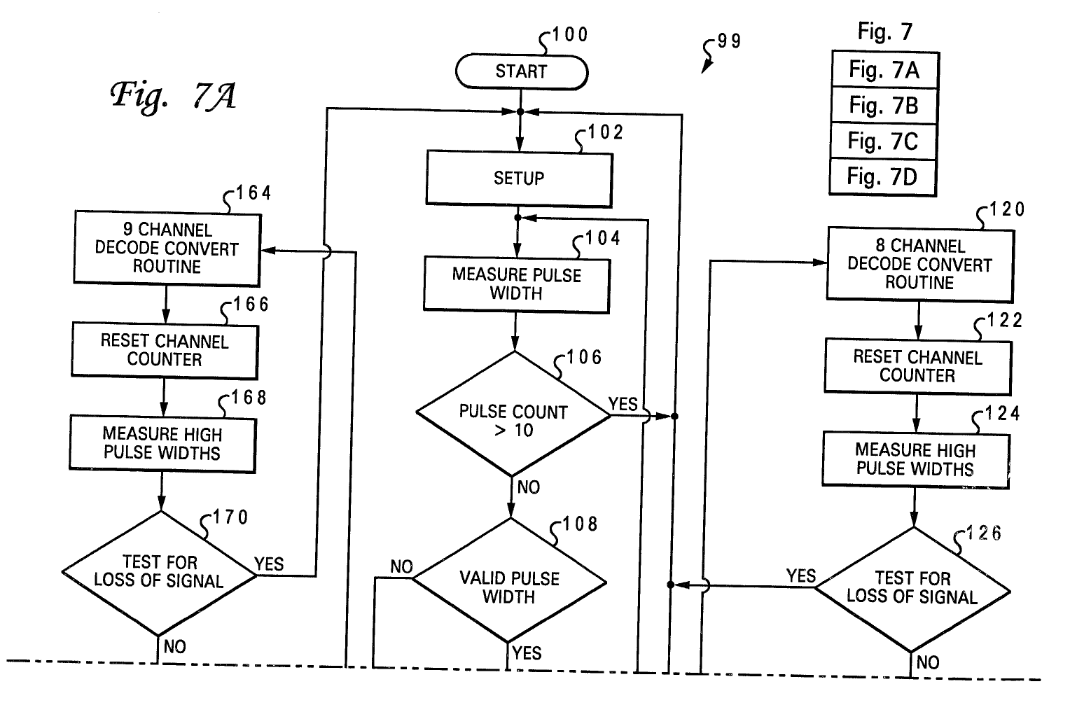

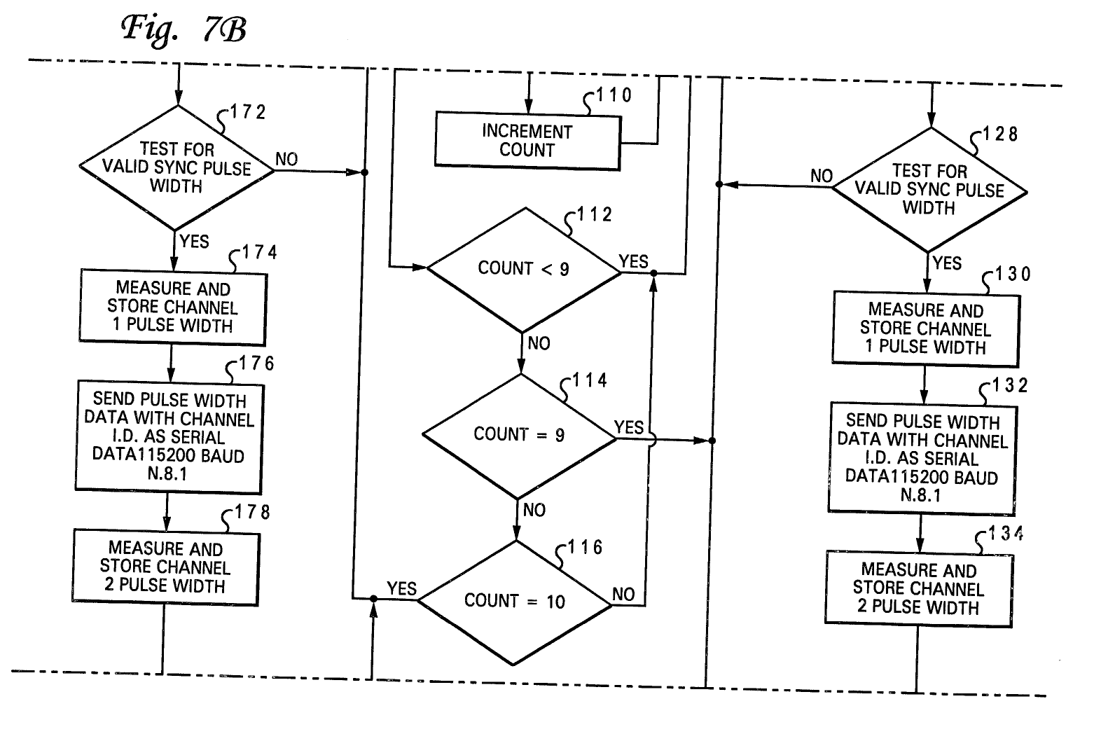

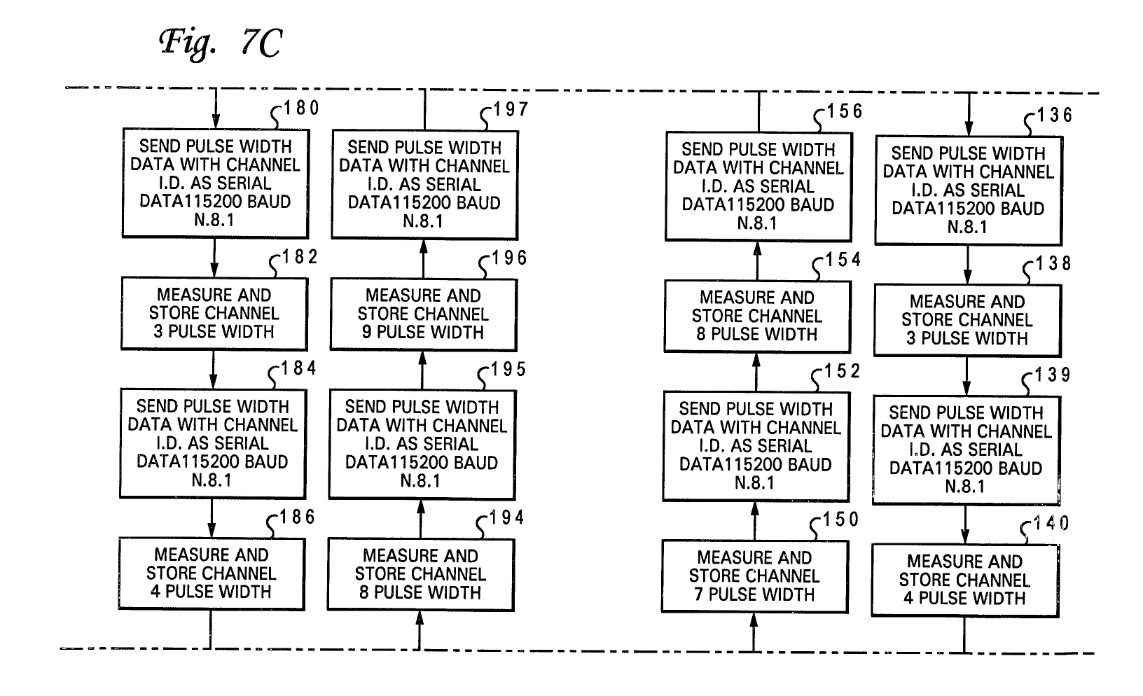

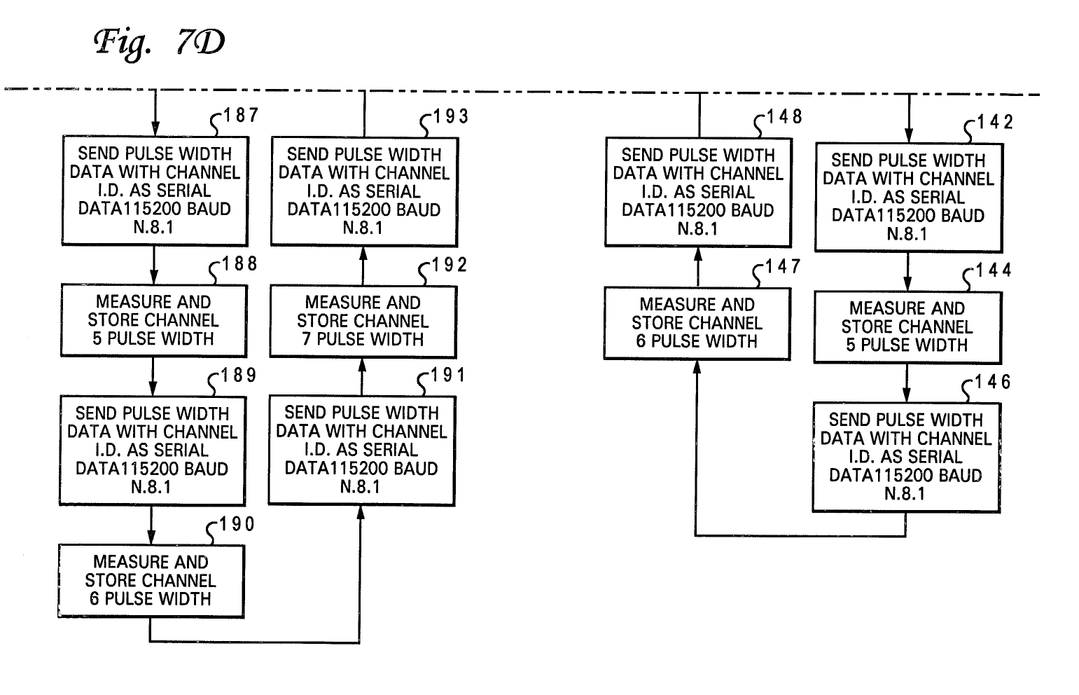

FIG. 7 is a flow chart of the programming executed by microcontroller 60 to convert pulse width modulation waveforms to serial digital data. The program 99 is generalized to ease installation to different systems. Program 99 automatically detects how many channels of control exist, based on the number of pulses occurring between and adapts its operation to accommodate the different number of channels. Program 99 provides for determining the position in the recurring sequence of channel pulses to allow identifying data to be inserted into the packets of data generated for each channel. Program 99 executes in a continuous loop as long as microcontroller 60 is powered, entering the loop at step 100. As used herein the term “channel pulse” is to be distinguished from a “reference pulse”. Channel pulse duration has significance for control of a model vehicle. A reference pulse simply sets of recurring sequential strings off channel pulses.

Program 99 begins with a setup step 102, in which a temporary data storage variable is defined and a pulse loop counter is defined. In addition, conventional resource definitions occur particularly relating to setup of a USART channel (pin PC6) to define: the number of bits; parity; etc.; and to set the baud rate. In addition, a threshold level is set for locating leading and trailing edges associated with pulses received from the PPM/PDM generator.

As an initial matter program 99 must determine the number of channels of control the system has, which in turn requires locating a reference pulse at the beginning of a group of channel pulses. At step 104 pulse duration between leading and trailing edges is measured for the first full pulse detected. Next, at step 106, the pulse count is checked to determine if the number of channel pulses has exceeded a maximum allowable number, here set at 10. If the count exceeds 10 it indicates an error condition and the program loop is returned to the setup step 102 to reinitialize variables and counters. Initially the counter will equal 1 with the result that the program falls through to step 108, where the duration of the pulse is compared to lower and upper limits to determine if the duration falls in the allowed range for a channel pulse. If the pulse duration falls within the allowable range the pulse count is incremented at step 110 and the program loops back to step 104 to measure the duration of the next pulse in series, which may be another channel pulse, or which may be a reference pulse. This loop continues until a pulse duration is measured which does not fall within the predefined limits as determined at step 108, which will normally be a reference pulse. The loop counter should never exceed 10 before a reference pulse is encountered.

Once a reference pulse has been encountered, it may be determined if a valid count of the number of channels has been obtained. Following the NO branch from step 108, step 112 is executed to determine if the pulse count is less than 9, indicating that an incomplete sequence of pulses was encountered. If yes, the program is looped back to the setup step 102. Otherwise, the program advances to step 114, where it is determined if the pulse count equals nine, in which case the execution proceeds to the eight channel conversion routine beginning at step 120. In the count did not equal nine at step 114, then execution continues to step 116, where it is determined if the count equaled ten. If YES, then execution moves to the nine channel data conversion routine beginning at step 164. If not, an error has occurred and the program loops back to setup step 102.

The eight channel and nine channel data conversion routines are substantially similar to one another and, while in the preferred environment, they do not share code, they could be implemented to do so if available storage capacity for the program is highly constrained by selection of an alternative microcontroller, or becomes constrained by adding features to the existing programming. The beginning of the eight channel data encoding routine is indicated at step 120. As an initial matter a reference pulse must be located so that channel pulses are converted to digital data beginning with the first pulse in the sequence. Data packets generated for each pulse are numbered in sequence to allow recovery by the receiving unit in the model vehicle. The channel counter is reset to 1 at step 122. An initial measurement of high pulse duration is made at step 124. This measurement is compared to minimum and maximum duration periods to determine if a loss of signal condition has occurred. The loss of signal conditions are absence of a high pulse or a high pulse duration exceeding the maximum allowed duration of the reference pulse. If a loss of signal condition has occurred, the program loops back to setup step 102. Next the measured duration is compared to the expected reference pulse value at step 128. If the pulse duration fails to meet the expected reference pulse value the program loops back to step 120 to continue looking for a reference pulse. Once a reference pulse is located, generation of serial digital data commences along the YES branch from step 128.

Steps 130 to 156 provide for the measurement of the duration of each channel pulse in turn following a reference pulse for eight channel pulses. The duration of each pulse is measured and quantized (i.e. assigned a discrete numerical value within the 16 bit resolution provided by having two bytes available for data). This is done by initiating a 16 bit timer upon detection of the leading edge of a pulse. The timer is stopped with detection of the trailing edge. The timer is cleared for each new pulse duration measurement. A channel identification flag precedes the two data bytes in a packet and the entire packet is transmitted as serial digital data. Once all eight channels have been processed, program execution loops back to step 120. Since the channels are related to the model variable controlled by their position in the sequence of channel pulses, the flags providing for identification of the data packets can be arbitrary as long as they are unique.

The beginning of the nine channel data encoding routine is indicated at step 164. As an initial matter a reference pulse must be located so that channel pulses are converted to digital data beginning with the first pulse in the sequence. Data packets generated for each pulse are numbered in sequence to allow recovery by the receiving unit in the model vehicle. The channel counter is reset to 1 at step 166. An initial measurement of high pulse duration is made at step 168. This measurement is compared to minimum and maximum duration periods to determine if a loss of signal condition has occurred. The loss of signal conditions are absence of a high pulse or a high pulse duration exceeding the maximum allowed duration of the reference pulse. If a loss of signal condition has occurred, the program loops back to setup step 102. Next the measured duration is compared to the expected reference pulse value at step 172. If the pulse duration fails to meet the expected reference pulse value the program loops back to step 164 to continue testing for a reference pulse. Once a reference pulse is located, generation of serial digital data commences along the YES branch from step 172.

Steps 174 to 197 provide for the measurement of the duration of each channel pulse in turn following a reference pulse for 9 channel pulses. The duration of each pulse is measured and quantized (i.e. assigned a discrete numerical value within the 16 bit resolution provided by having two bytes available for data). This is done by initiating a 16 bit timer upon detection of the leading edge of a pulse. The timer is stopped with detection of the trailing edge. The timer is cleared for each new pulse duration measurement. Pulse duration measurements are quantized to a level within the resolution provided by the number of available bytes. A channel identification flag precedes the two data bytes and the entire packet is transmitted as serial digital data. Once all nine channels have been processed, program execution loops back to step 164.

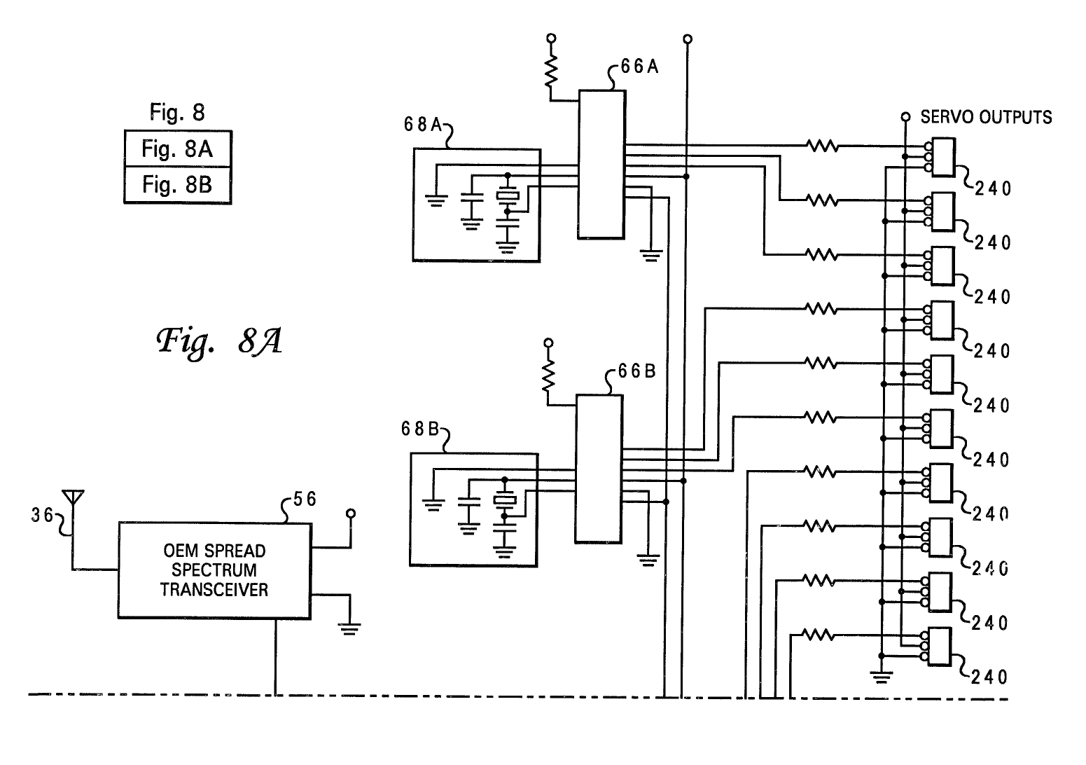

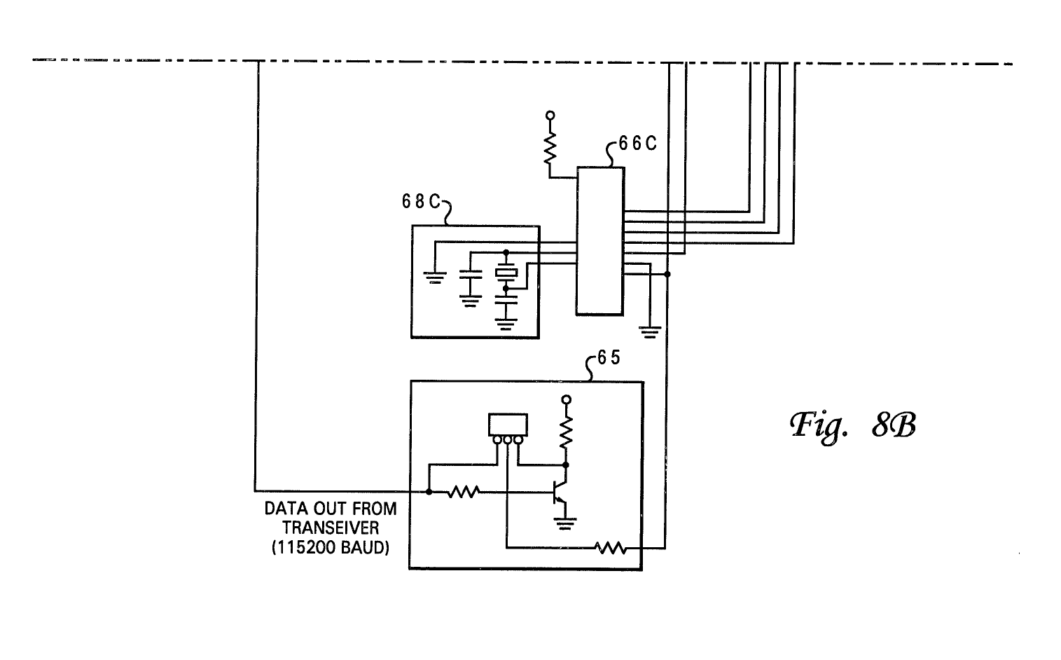

FIG. 8 illustrates a receiving and decoding unit for installation in a remotely controlled model. Signals are received on an antenna 36 and applied to spread spectrum transceiver 56, which is synchronized with transceiver 54 through the execution of the same algorithm for the generation of pseudo-random frequency skips. The serial digital data stream is recovered and passed to an amplifying element 65. The data stream is applied to input ports on each of three identical programmable microcontrollers 66A, 66B and 66C. The microcontrollers are PIC16F873 programmable microcontrollers. Each microcontroller is provided with an external crystal controlled clock, 68A, 68B and 68C, respectively. Three parallel microcontrollers are used because the maximum clock speed usable with the processor selected is insufficiently fast to allow recovery and regeneration of duration modulated pulse in the gap between the receipt of packets. It is essential to avoid overlay and missed packet reads. Accordingly, each processor handles recovery and regeneration of only every third channel pulse. The use of faster, more expensive microcontrollers could, in some circumstances, allow the use of fewer microcontrollers. Alternatively, increased data conversion and throughput can be achieved by increasing the number of parallel microcontrollers. The programs executed by microcontrollers 66A, 66B or 66C run in simultaneously.

Microcontroller 66A is connected to provide outputs to three servo output buffers 240. Similarly, microcontroller 66B is connected to provide outputs to another three servo output buffers 240. Lastly, microcontroller 66C is connected to provide output pulses to four servo output buffers 240, illustrating that the number of servos connected to the processors does not have to be evenly divisible by the number of processors.

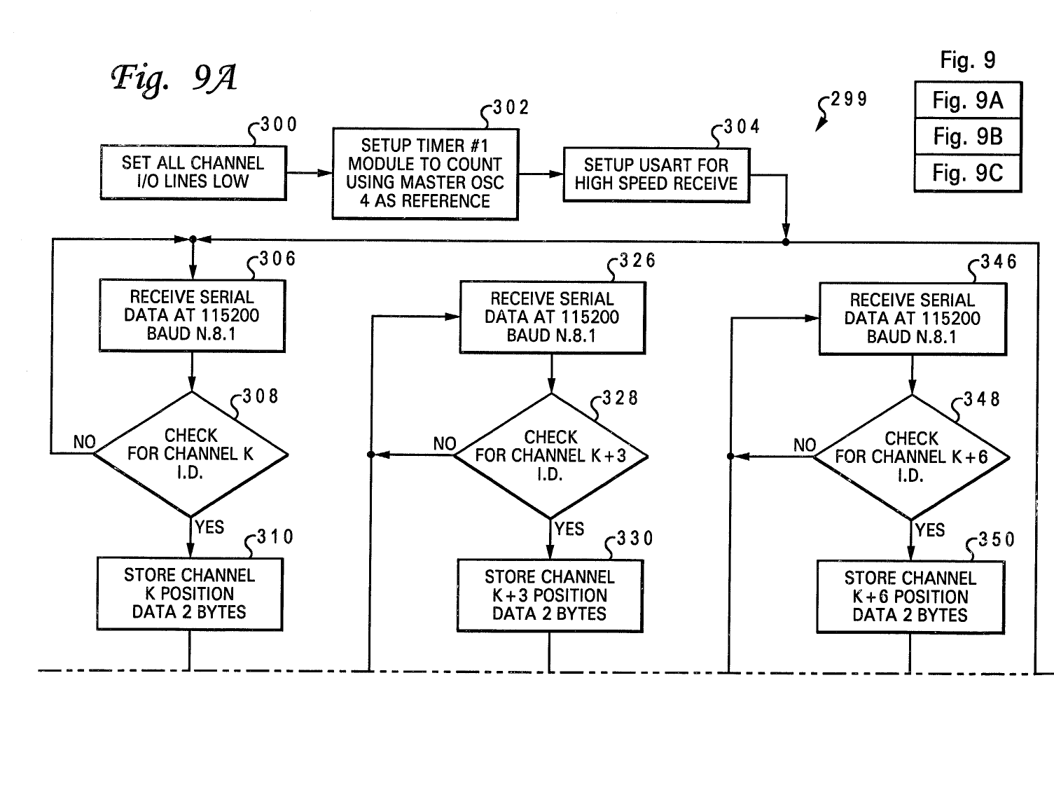

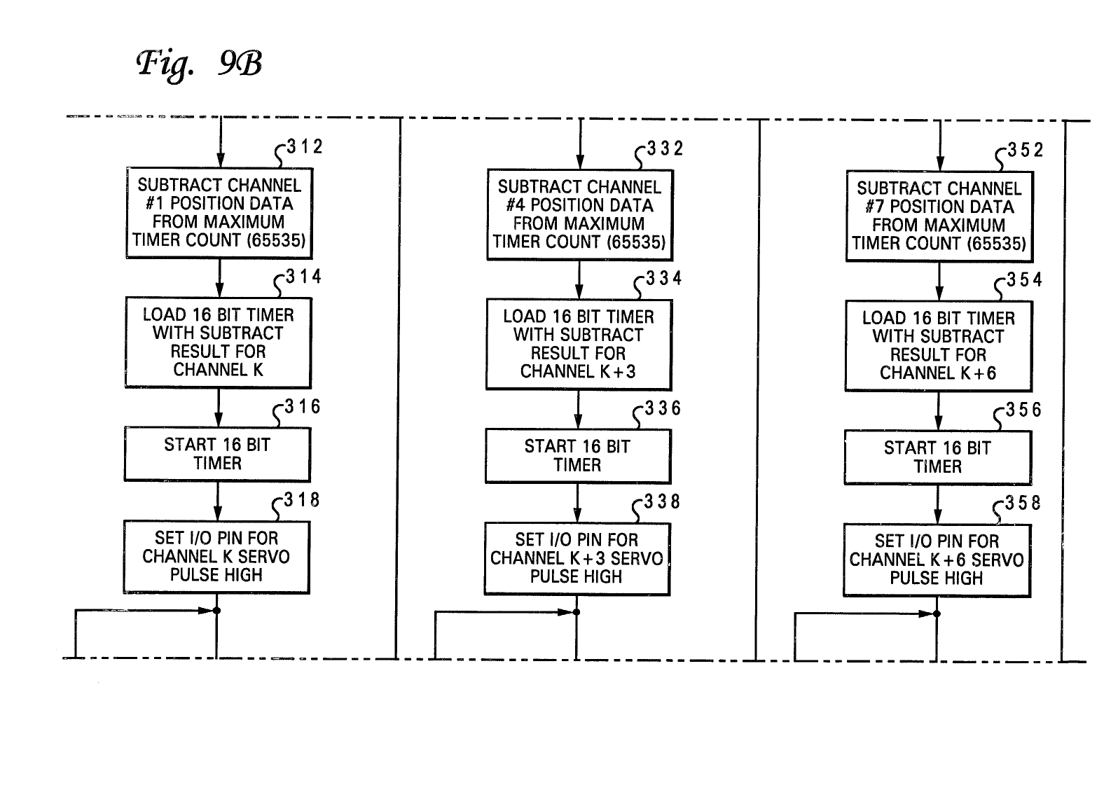

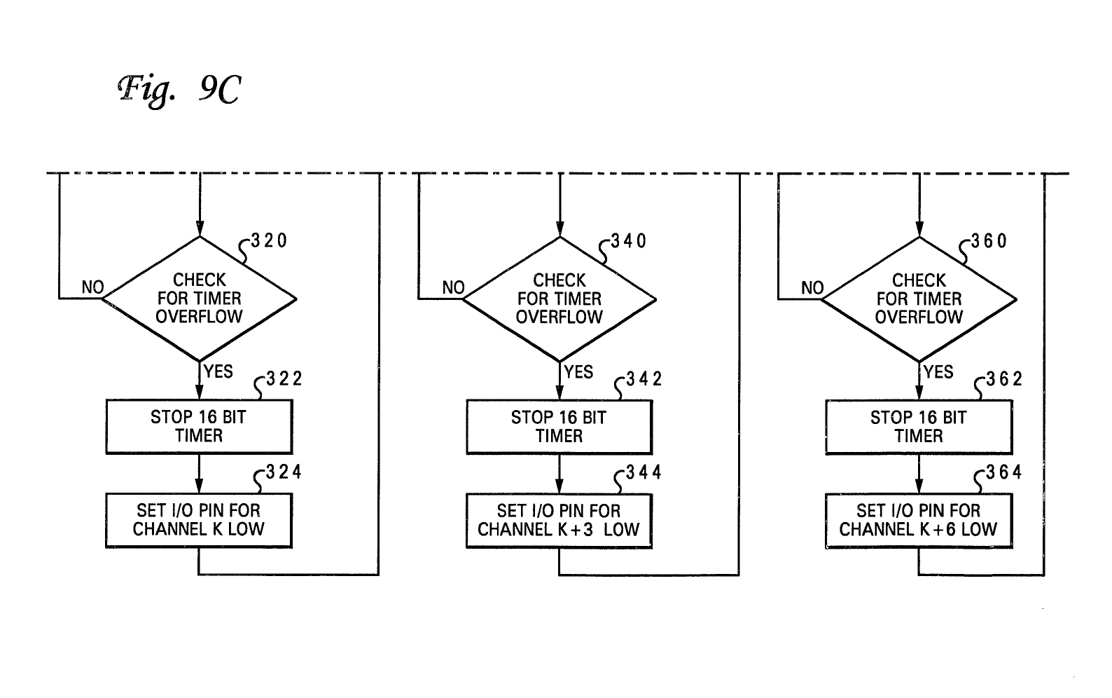

FIG. 9 exemplifies the algorithm 299 executed by each one of microcontrollers 66A, 66B or 66C. Essentially, each major segment of the program is associated with a particular servo for control and is used to control an output port of the processor coupled to the servo, as illustrated in FIG. 8. Each major segment screens the channel flag bytes of each packet received, and upon receipt of the packet intended for decoding by the segment sets a timeout variable using the data of the last two bytes of the packet. A timer is started and the associated output port is set high simultaneously. Once the timer runs out, the output port is returned to its default, low output. The period of high output generates or reconstructs the pulse width modulation signal intended for the particular servo to which it is applied.

The program 299 executed by each of the three microcontrollers is identical except for the flag filters which determine which data packets will be accepted for processing by a particular processor and the output ports which are controlled. Because the processors also sort the pulses for direct application to each of servos 40, there is no need to reconstruct the original PPM/PDM signal. Indeed, in an alternative form of the invention, no such signal need ever have existed. In such cases, the microcontrollers generate PDM control signals for the servos from recovered original digital signals. No change is necessarily required in the recovery program to work in the alternative embodiment of the invention.

Program 299 begins operating when the receiving unit for a model is turned on. At step 300 all channel input/output pins for the microcontroller are set low, which are the their default states for the I/O pins. These pins are the I/O pins tied to servo drivers 240 as illustrated in FIG. 8. Pulse duration modulation servo control signals will be generated on these I/O pins corresponding to each channel of control. Next, as step 302, a timer module is step up. At step 304 a USART port is setup to receive high speed serial digital data. With preliminary matters completed, program 299 enters an endless loop having three major sections, relating to three I/O pins for which the program recovers pulse duration modulation servo control signals.

Program 299 is illustrated with reference to a nine channel system. For an eight channel system, the program may be modified to bypass one of the channel recovery sections on one microcontroller. Additional channels can be readily handled by adding a segment. Each major segment of the loop is set of by check for channel flag. At step 306, a packet recovered by the spread spectrum transceiver 56 is received as serial digital data. The first byte which flags which channel the data is directed to is compared with a filter K at step 308. K represents one of channels 1, 2 or 3, depending upon which microcontroller program 299 is running. Until a packet having a flag matching the filter is received the program loops back along the NO branch to received each successive packet.

Once a packet passes the flag check, execution passes along the YES branch from step 308 to step 310 and the last two bytes of the packet, representing a quantization of the duration of a servo control pulse are stored. At step 312 the quantization is subtracted from the maximum timer count. At step 314 the result of the subtraction of step 312 is loaded in a timer. At step 316 the timer is started and immediately afterwards at step 318 the I/O pin associated with the servo to be controlled is set high. Step 320 matches the timer count against overflow, indicating that the I/O pin has been held high for the duration of the original servo control pulse. The timer is stopped at step 322 and the I/O pin is set low at step 324. Execution then moves to step 326 for receipt of subsequent data packets. Steps 326 through 344 math steps 306 through 324, except that flag filters are set for channels 4, 5 or 6, depending on the microcontroller. After completing step 324 execution moves to step 326. Similarly steps 346 through 364 again repeat the process, except for channels 7, 8 or 9. After step 364 processing loops back to step 306 for the first set of channels. Because the channels are transmitted in the original order of the PDM waveform, program 299 will advance execution on a repeating basis through each of the three (or two) channels it is to handle.

FIG. 10 illustrates in block diagram form circuitry for a hand held controller for an alternative form of the invention. Here the hand held controller does not generate a PDM scan signal, but instead directly generates digital encoding for joystick position. Digital control unit 79 includes a joystick 22, the position of which is scanned and converted to digital format by A/D converter 81. A flag is added by a flagging section 83, which may be part of the A/D converter. The digital signal is then applied to a frequency hopping spread spectrum transceiver 54 for broadcast over antenna 28. PDM signals are generated (rather than reconstructed) at the receiving end in the same manner as before.

The invention provides a data encoding and decoding system, allowing conventional proportional control servo systems, used with remote controlled models, to use digital transmission techniques. This in turn allows the use of inexpensive OEM spread spectrum transceivers. Spread spectrum techniques in themselves allow a greater number of users in a given frequency band at a substantially reduced chance of mutual interference. In addition, inexpensive spread spectrum transceivers, authorized for use in the ISM band, greatly expand the data bandwidth available between a controller and a controlled model. This has the potential to allow more model variables to be controlled and opens the possibility of full duplex communications. The present invention comprehends the possibility of forms of electromagnetic radiation other than radio.

While the invention is shown in only one of its forms, it is not thus limited but is susceptible to various changes and modifications without departing from the spirit and scope of the invention.

What is claimed is:

1. A remote control system, comprising:
a controlled device having a plurality of servo systems;
a signal generator for providing fixed length digital control signals relating to each of a plurality of servo systems;
a transmitter coupled to receive the fixed length digital control signals and for modulating a transmission signal with the fixed length digital control signals;
a receiver for receiving the transmission signal and recovering the fixed length digital control signals; and
a servo control signal generator coupled to receive the recovered fixed length digital control signals and responsive thereto for generating servo control signals sorted by servo system to be controlled.

2. A remote control system as claimed in claim 1, wherein the servo control signals are pulse duration modulated signals.

3. A remote control system as claimed in claim 2, further comprising:
a hand held controller including the signal generator and the transmitter; and
a model vehicle including the plurality of servo systems, the receiver and the servo control signal generator.

4. A remote control system as claimed in claim 3, wherein the signal generator includes:
a plurality of positionable input devices providing control over the plurality of servo systems;
a pulse duration modulated signal generator for generating a scan signal characterized by a periodic reference pulses marking sets of duration modulated pulses relating to positions of the input devices; and
an encoding section receiving the scan signal and converting the duration modulated pulses occurring therein into the fixed length digital control signals.

5. A remote control system as claimed in claim 4, further comprising:
the fixed length digital control signals being multiple byte packets including a flag byte identifying a servo channel to which the packet relates.

6. A remote control system as claimed in claim 5, wherein the receiver and the transmitter are synchronized spread spectrum transceivers.

7. A remote control system as claimed in claim 3, wherein the signal generator includes:
a plurality of positionable input devices providing control over the plurality of servo systems; and
an encoding section for scanning the positions of the plurality of input devices and providing fixed length digital control signals representative thereof.

8. A remote control system as claimed in claim 6, wherein the servo control signal generator comprises a plurality of parallel connected programmable microcontrollers, each programmable microcontroller having a plurality of input/output pins with each servo system being coupled to one input/output pin.

9. A remote control system as claimed in claim 7, wherein the servo control signal generator comprises a plurality of parallel connected programmable microcontrollers, each programmable microcontroller having a plurality of input/output pins with each servo system being coupled to one input/output pin.

10. A remote control system, comprising:
a controlled device having a plurality of servo systems;
a controller having a positionable input device;
a pulse generator responsive to the positionable input device for generating a pulse duration modulated signal in which successive pulses in a string of pulses are associated with one each of the plurality of servo systems;
a converter connected to receive the pulse duration modulated signal for measuring the duration of each pulse, quantizing the measurements and encoding the measurements as fixed length digital code;
a spread spectrum transmitter connected to receive the fixed length digital code, for modulating successive carriers with the fixed length digital code and transmitting the modulated carriers;
a receiver installed on the controlled device for receiving the modulated carriers and recovering the fixed length digital code; and
a decoder installed on the controlled device and connected to receive the fixed length digital code for regenerating the pulses and applying the pulses to the appropriate servo systems.

11. A remote control system as claimed in claim 10, wherein the decoder further comprises:
a plurality of programmable microcontrollers, each connected to receive the recovered fixed length digital code, and with each programmable microcontroller connected by output pins to an exclusive subset of the servo systems.

12. A remote control system as claimed in claim 11, wherein the fixed length digital code comprises a flag identified with a particular servo system.

13. A remote control system as claimed in claim 12, further comprising:
the converter being a programmable microcontroller; and
a program stored on the programmable microcontroller which upon execution detects the number of pulses relating to servo systems.

14. A control system for servos installed on a model vehicle, where particular servos are controlled by the application thereto of variable duration pulses, the control system comprising:
a source of sets of fixed length digital code identified with the particular servos;
a spread spectrum transceiver coupled to receive the sets of fixed length digital code and modulating successive carriers with the sets of fixed length digital code for transmission;
a receiver installed on the model vehicle for receiving the successive carriers and recovering the sets of fixed length digital code;
a decoder installed on the model vehicle and coupled to receive the recovered sets of fixed length digital code, the decoder providing for sorting the sets of fixed length digital code by servo and for generating variable duration pulses for the servos from the fixed length digital code.

15. A control system as claimed in claim 14, further comprising:
the decoder having a plurality of parallel sections, each section being adapted to take spaced sets of fixed length data code.

16. A control system as claimed in claim 15, the source of sets of fixed length digital code further comprising:
a generator of variable duration pulses; and
an encoder for detecting leading and trailing edges of the variable duration pulses, measuring their duration and generating sets of fixed length digital code, the sets of the fixed length digital code including a flag identifying a particular set of fixed length digital code with a particular servo and data representing a quantization of a variable duration pulse.

17. A control system as claimed in claim 16, the encoder further comprising:
a programmable microcontroller; and
a program stored on the programmable microcontroller adapted to detect the number variable duration pulses relating to servos.

18. A method of encoding and decoding a series of pulse duration modulated signals for digital transmission, the method comprising the steps of:
measuring the duration of the pulse duration modulated signals;
assigning each successive pulse duration modulated signal an identifying flag based on position in the series;
quantizing the measured duration of each pulse duration modulated signal and placing the identifying flag and the quantization into a fixed length digital code set for each pulse duration modulated signal;
providing first and second transceivers;
providing the sets of fixed length digital code to the first transceiver for broadcast;
receiving the sets of fixed length digital code on the second transceiver;
sorting the sets of fixed length digital code based on flag values; and
regenerating pulse duration modulation signals from the quantization values.

19. A method of encoding and decoding as claimed in claim 18, comprising the further steps of:
applying the regenerated pulse duration modulation signals to servos.

20. A method of encoding and decoding as claimed in claim 19, wherein the first and second transceivers are spread spectrum transceivers.

21. A method of encoding and decoding as claimed in claim 19, further comprising the step of using practicing the quantizing step in a hand held wireless controller.

22. A method of encoding and decoding as claimed in claim 21, further comprising the steps of:
providing a model vehicle; and
providing programmable microcontrollers in the model vehicle for carrying out the sorting and regenerating steps.

23. A wireless system for controlling model vehicles from a hand held control unit, comprising:
a plurality of positionable input devices on the hand held control unit;
a control pulse generator for converting positions of the positionable input devices into channel pulses, sequences of which are separated by reference pulses in the hand held control unit;
a converter operating on the sequences of channel pulses and reference pulses to generate serial digital data identified by channel in the hand held control unit;
a first spread spectrum transceiver for broadcasting the serial digital data from the hand held control unit;
a second spread spectrum transceiver for receiving the serial digital data at the model vehicle; and
a decoder operating on the serial digital data to sort the data and regenerating channel pulses therefrom.

24. A wireless system as claimed in claim 23, further comprising:
a plurality of servos installed on the model vehicle, the regenerated channel pulses being applied thereto for their control.
